(19) United States
(12) Patent Application Publication
(10) Pub. No.: US 2011/0055177 A1
(43) Pub. Date: Mar. 3, 2011

(54) COLLABORATIVE CONTENT RETRIEVAL USING CALENDAR TASK LISTS

(75) Inventors: Al Chakra, Apex, NC (US); Yongcheng Li, Cary, NC (US); Yuping C. Wu, Cary, NC (US)

(73) Assignee: International Business Machines Corporation, Armonk, NY (US)

(21) Appl. No.: 12/548,192

(22) Filed: Aug. 26, 2009

(51) Int. Cl. G06F 7/10; G06F 17/30

(52) U.S. Cl. 707/695; 707/E17.044; 707/E17.005; 707/E17.014; 707/608

(57) ABSTRACT

Calendar applications typically require users to enter information about unfinished tasks and notify users of the unfinished tasks by generating reminders at set times. Collaboration on shared content is not effective unless all collaborators are aware of a current status, a current version of the shared content, and modifications made to the shared content. Functionality can be implemented to link the calendar application to the shared content via an interface to enable the collaborators to store different versions of the shared content, access the shared content from any location via the calendar application, and receive notifications of the modifications made to the shared content. Moreover, the calendar application being used to control access to the shared content among the collaborators can also ensure collaboration without the need for configuring and using a version controlling system or collaborative servers.

### BACKGROUND

Embodiments of the inventive subject matter generally relate to the field of computers, and more particularly, to techniques for collaborative content retrieval using calendar task lists.

Calendar applications are often used to remind a user of unfinished tasks. The calendar applications typically rely on users to enter information about the tasks and are often limited to generating reminders at set times.

### SUMMARY

Embodiments include a computer-implemented method comprising detecting that an application for presenting a local version of a shared content has been launched. The shared content comprises content shared among a plurality of clients for collaboration. Collaboration settings indicating the plurality of clients collaborating on the shared content and indicating permissions associated with each of the plurality of clients for manipulating the shared content are received. A content listing for the shared content is created. The content listing indicates the collaboration settings for the shared content. The content listing is transmitted to a collaboration unit on a server, for storing in a content database. A modification of a current local version of the shared content is determined. The modification and an indication of the current local version of the shared content are communicated.

Another embodiment includes a computer program product for shared content retrieval, where the computer program product comprises a computer usable medium comprising computer usable program code. The computer usable program code is configured to detect that an application for presenting a local version of a shared content has been launched. The shared content comprises content shared among a plurality of clients for collaboration. The computer usable program code is configured to receive collaboration settings indicating the plurality of clients collaborating on the shared content and indicating permissions associated with each of the plurality of clients for manipulating the shared content. The computer usable program code is also configured to create a content listing for the shared content, where the content listing indicates the collaboration settings for the shared content. The computer usable program code is further configured to transmit the content listing to a collaboration unit on a server, for storing in a content database. The computer usable program code is configured to determine a modification of a current local version of the shared content and communicate the modification and an indication of the current local version of the shared content.

Another embodiment includes an apparatus comprising a processor, a network interface coupled with the processor, a calendar application for presenting a status and modification of a shared content, where and a machine-readable media encoded with a client calendar interface configured to detect that an application for presenting a local version of a shared content has been launched. The shared content comprises content shared among a plurality of clients for collaboration. The client calendar interface is configured to receive collaboration settings indicating the plurality of clients collaborating on the shared content and indicating permissions associated with each of the plurality of clients for manipulating the shared content. The client calendar interface is also configured to create a content listing for the shared content. The content listing indicates the collaboration settings for the shared content. The client calendar interface is further configured to transmit the content listing to a collaboration unit on a server, for storing in a content database. The client calendar interface is configured to determine a modification of a current local version of the shared content and to communicate the modification and an indication of the current local version of the shared content.

### BRIEF DESCRIPTION OF THE DRAWINGS

The present embodiments may be better understood, and numerous objects, features, and advantages made apparent to those skilled in the art by referencing the accompanying drawings.

FIG. 1 is a conceptual block diagram illustrating configuring shared content access via a client calendar interface.

FIG. 2 is a conceptual block diagram illustrating shared content access via a client calendar interface.

FIG. 3 is a flow diagram illustrating example operations for creating a calendar content listing for shared content.

FIG. 4 is a flow diagram illustrating example operations for sharing content via a client calendar interface.

FIG. 5 is a flow diagram illustrating example operations for creating and transmitting notifications in a collaborative environment via a client calendar interface.

FIG. 6 is an example computer system configured for managing shared content via a client calendar interface.

FIG. 7 is an example block diagram configured for accessing shared content via a client calendar interface

### DESCRIPTION OF EMBODIMENT(S)

The description that follows includes exemplary systems, methods, techniques, instruction sequences, and computer program products that embody techniques of the present inventive subject matter. However, it is understood that the described embodiments may be practiced without these specific details. For instance, although examples refer to a client calendar interface dynamically populating a calendar to-do list, the calendar to-do list may also be manually populated (e.g., a user may create a new content listing in the to-do list, modify the content listing information, etc). In other instances, well-known instruction instances, protocols, structures, and techniques have not been shown in detail in order not to obfuscate the description.

Collaboration on shared content (e.g., a presentation, a project report, etc.) is efficient when collaborators are aware of a current status, a current version of the shared content, and modifications made to the shared content. Typically, the collaborative experience stops as soon as one of the collaborators checks out the shared content from a repository until the collaborator checks the shared content back into the repository. A client calendar interface configured for assisting the collaborators to access the shared content and track modifications made to the shared content can enhance the quality of the collaboration. The client calendar interface can also track the status of the shared content and allow the collaborators to access the shared content via a calendar application. Knowing the current status of the shared content (e.g., who is currently working on the shared content) and viewing a current version of the shared content can enhance the collaboration experience and avoid conflicts caused by multiple collaborators simultaneously editing the shared content. Other collaborators may also be allowed to simultaneously work on unfinished shared content without the need for configuring and using a version controlling system or configuring collaborative servers requiring additional administrative work.

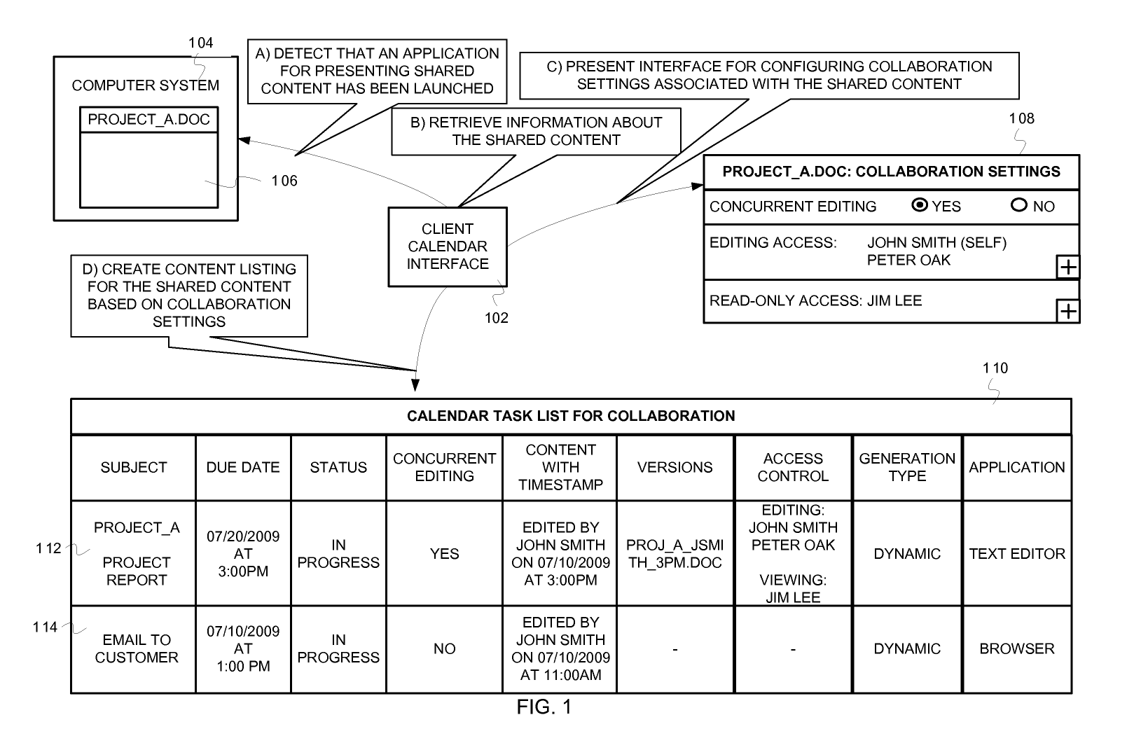

FIG. 1 is a conceptual block diagram illustrating configuring collaborative content access via a client calendar interface. FIG. 1 depicts a client calendar interface 102. The client calendar interface 102 acts as an interface between applications running on a computer system 104 and a calendar application (not shown). The calendar application and the client calendar interface 102 may also run on the same computer system 104. FIG. 1 also depicts a document 106 (project_A. doc) presented by one of the applications running on the computer system 104.

At stage A, the client calendar interface 102 determines that an application for presenting content shared between multiple users (“shared content”) has been launched. The shared content may be a document, a presentation, a multimedia file, etc., shared between the multiple users for collaboration (“collaborators”). For example, the text editor presents a project report (i.e., shared content). In one implementation, the client calendar interface 102 can periodically query the application to determine how many files are being presented by the application. For example, the client calendar interface 102 may query a text editor to determine how many files are being presented by the text editor. In another implementation, the application can generate a notification and transmit the notification (e.g., using techniques for inter process communication) to the client calendar interface 102 every time the user launches a new instance of the application. In some implementations, a new application instance may be launched to present different content shared among the collaborators. The client calendar interface 102 can query a task manager at specified intervals of time to determine whether a new instance of the application has been launched. For example, the client calendar interface 102 may query the task manager to determine how many instances of the text editor have been launched. In another implementation, the task manager or operating system can use interrupts (e.g., hardware interrupts, software interrupts, etc.) to notify the client calendar interface 102 when the user launches the application, opens a new file, etc.

At stage B, the client calendar interface 102 retrieves information about the shared content. For example, for an email opened in an email editor, the client calendar interface 102 may retrieve information such as a sender's name, a recipient's name, an email subject, a date of creation, a date last saved, etc. As another example, the client calendar interface 102 may retrieve, from a text file, a name/identification number of a user who created the text file, a date when the user created the text file, a date when the user last modified the text file, etc. In some implementations, the client calendar interface 102 may retrieve properties associated with the application presenting the shared content. For example, the client calendar interface 102 may determine properties such as a version number of the application.

At stage C, the client calendar interface 102 presents an interface for configuring collaboration settings associated with the shared content. In FIG. 1, the client calendar interface 102 presents a collaboration configuration interface 108 for configuring the collaboration settings for the document 106. The collaboration configuration interface 108 can enable the user to indicate other collaborators for the document 106. As depicted, the user specifies a set of collaborators that are allowed to edit the document 106 by granting “editing access”. The user can also specify collaborators with read-only access to the document 106. The user can also indicate whether the collaborators with editing access should be allowed to concurrently edit the document 106.

At stage D, the client calendar interface 102 creates a content listing 112 in a calendar task list 110 for the shared content based on the collaboration settings. The calendar task list 110, also known as a to-do list, comprises a subject (e.g., a name of the document 106, a description of the document 106, etc.), a current status of the document 106, when and by whom the document 106 was last edited, whether the document 106 can be concurrently edited, available versions (e.g., edited by different collaborators) of the document 106, and a list of collaborators with editing access and read-only access. Additionally, the calendar task list 110 also indicates a due date for the document 106, a generation type (i.e., whether the content listing was created by the client calendar interface 102 or manually), and the application being used to present the document 106. In some implementations, the calendar task list 110 can also indicate information about a task category indicating, e.g., whether the task is a personal project, a customer related task, etc. The calendar task list 110 may also indicate a person to whom the task should be submitted (e.g., a project report may be submitted to a project manager, a customer email may be sent to a customer, etc.).

The content listing 112 for the document 106 describes properties of the document 106, a status of the document 106, and collaboration settings for the document 106. The subject for the content listing 112 indicates a project name (i.e., project_A) and a description (i.e., project report). The content listing 112 indicates a due date of Jul. 20, 2009 at 3:00 pm for the document 106, that work on the document 106 is in progress, that the collaborators can concurrently edit the document 106, and that the document 106 was last edited by John Smith on Jul. 10, 2009 at 3:00 pm. The calendar content listing 112 also presents links to available versions of the document 106. Here, one version of the document (i.e., proj_A_JSmith_{—}3pm.doc) is available. The name of the document 106 can indicate who edited the document 106 and when the document 106 was edited. The calendar content listing 112 also indicates that John Smith and Peter Oak have editing access to the document 106, while Jim Lee can view but cannot edit the document 106. Lastly, the calendar content listing 112 for the document 106 indicates that the calendar content listing 112 was dynamically generated by the client calendar interface 102 and that a text editor is used to present the document 106.

The calendar task list 110 comprises another content listing 114 for an email to a customer as indicated by the subject for the content listing 114. The content listing 114 indicates that the email should be sent no later than a due date of Jul. 10, 2009 at 1:00 pm, that work on the email is in progress, and that the email was last edited by John Smith on Jul. 10, 2009 at 11:00 am. As depicted in the calendar content listing 114, the email has no collaborators (i.e., other users are not allowed to view/edit the email). Lastly, the calendar content listing 114 indicates that the client calendar interface 102 dynamically generated the calendar content listing 114 for the email and that a web browser is used to present the email. Additionally, the client calendar interface 102 can also transmit the calendar task list 110 comprising the content listings 112 and 114 to a collaboration unit (not shown) on a server. The collaboration unit may receive and store calendar task lists received from each of the collaborators.

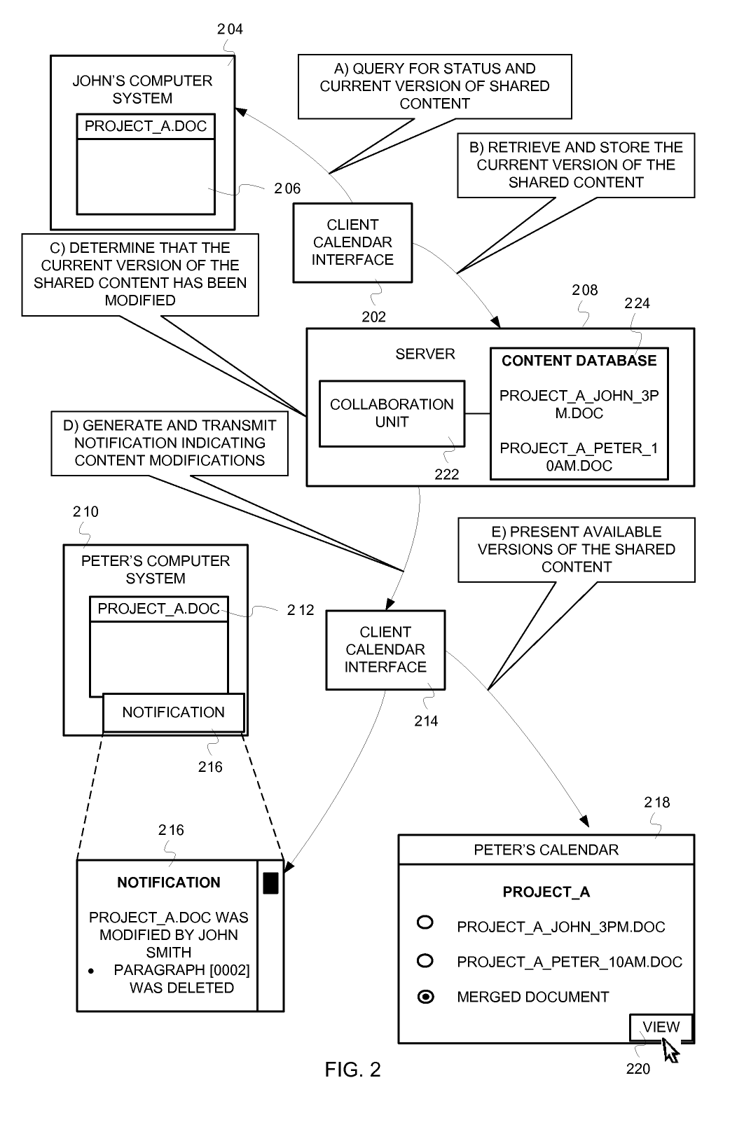

FIG. 2 is a conceptual block diagram illustrating shared content access via a client calendar interface. FIG. 2 depicts a client calendar interface 202. The client calendar interface 202 acts as an interface between applications running on John's computer system 204 and a calendar application (not shown). The calendar application and the client calendar interface 202 may also run on the computer system 204. FIG. 2 also depicts a local version of a document 206 (project_A. doc) presented by one of the applications running on the computer system 204. Likewise, FIG. 2 also depicts Peter's computer system 210, which presents a local version of the document 212 (project_A.doc). A second client calendar interface 214 acts as an interface between applications running on Peter's computer system 210 and Peter's calendar application 218. The calendar application 218 and the client calendar interface 214 may also run on the computer system 210. Additionally, the client calendar interfaces 202 and 214 communicate with a collaboration unit 222 on a server 208. The server 208 also comprises a content database 224. The collaboration unit 222 is coupled with the content database 224.

At stage A, the client calendar interface 202 queries an application for status and a current version of the shared content presented by the application. For example, the client calendar interface 202 may query a text editor to determine when the document 206 was last edited. The client calendar interface 202 may also request, from the text editor, a current version of the document 206. The client calendar interface 202 may query the application at specified intervals of time (e.g., every five minutes, every hour, etc). The client calendar interface 202 may identify the applications that should be queried by querying a task manager, retrieving content listings from a calendar application's task list (e.g., the calendar task list 110 of FIG. 1), etc.

At stage B, the client calendar interface 202 receives the document 206 and transmits the document 206 to the collaboration unit 222 on the server 208. For example, the client calendar interface 202 may receive a current version of the document 206 from the text editor. In addition to transmitting the current version of the document 206 to the collaboration unit 222, the client calendar interface 202 may also indicate who edited the document 206 and at what time the document 206 was stored on the server 208. In some implementations, the client calendar interface 202 may also transmit an indication of the document 206 such as a location of the document 206, a name of the document 206, etc. to the collaboration unit. The collaboration unit 222 stores the document 206 in the content database 224. The collaboration unit 222 stores the document 206 such that the document name (e.g., project_A_John_{—}3pm) indicates that the document 206 was retrieved from John's computer system 204 and that the document 206 was stored in the content database 224 at 3 pm. Likewise, the client calendar interface 214 queries an application on Peter's computer system 210, receives a current version of the document 212 as edited by Peter, and transmits the document 212 to the collaboration unit 222. The collaboration unit 222 stores the document 212 in the content database 224 on the server 208. As described earlier, the collaboration unit 222 stores the document 212 such that the document name (e.g., project_A_Peter_{—}10am) indicates that the document 212 was retrieved from the application on Peter's computer system 210 and that the document 212 was stored on the server 208 at 10 am.

At stage C, the server 208 determines that the document 206 has been modified. The collaboration unit 222 on the server 208 may compare the stored current version of the document 206 with a last stored version of the document 206 and determine content modifications. In some implementations, the client calendar interface 202 may retrieve (e.g., from the content database 224 via the collaboration unit 222) the last stored version of the document 206, compare the last stored version of the document 206 with the current version of the document 206 (retrieved at stage B), and identify the content modifications. In some implementations, the application presenting the document 206 may keep track of the content modifications. The application may notify the client calendar interface 202 of the content modifications when the client calendar interface 202 queries the application for the status of the document 206. In addition to transmitting the document to the collaboration unit 222, the client calendar interface 202 may also transmit the content modifications (e.g., as part of metadata associated with the document 206).

At stage D, the collaboration unit 222 generates and transmits a notification indicating the content modifications. The collaboration unit 222 can identify collaborators to whom the notifications should be transmitted. In one implementation, the client calendar interface 202 may indicate, to the collaboration unit 222, collaborators with editing and viewing privileges. In another implementation, the client calendar interface 202 may store, on the server 208, the calendar task list (e.g., the calendar task list 110 of FIG. 1) for each of the collaborators. The collaboration unit 222 may retrieve a content listing for the document 206, identify the collaborators, and transmit the notification to the collaborators. In FIG. 2, the collaboration unit 222 transmits the notification 216 to Peter's computer system 210 via the client calendar interface 214. Alternatively, the client calendar interface 214 may present the notification 216 on the calendar application. The notification 216 indicates that John modified the document 206 for which Peter and John are collaborators. The notification also indicates the content modifications (e.g., paragraph [0002] was deleted, etc.)

At stage E, the client calendar interface 214 presents, on the calendar 218, available versions of the document 206 as part of a calendar content listing associated with the document 206 (e.g., in the version column of the calendar content listing 112 of FIG. 1). The client calendar interface 214 may present the available versions of the document 206 in response to a user request. In some implementations, the collaboration unit 222 on the server 208 may transmit notifications every time a new version of the document 206 is stored. The collaboration unit 222 may also indicate (e.g., as part of the notification) a location to the new version of the document 206. In response to the notification, the client calendar interface 214 may automatically update the calendar content listing on the calendar 218 and present a link to the new version of the document 206. As depicted in FIG. 2, two versions of the document—the document 206 edited by John and the document 212 edited by Peter that are stored in the content database 224 are presented on the calendar 218. The user (Peter) can select either of the two versions to view the document as edited individually by John and Peter. The calendar 218 also presents a merged document, comprising content modifications from both John and Peter. The content modifications made by the two users may be highlighted (e.g., using different fonts, different font colors, etc.) in the merged document.

It should be noted that the operations described with reference to FIGS. 1 and 2 are examples. For instance, although the FIGS. 1-2 describe the client calendar interface as an interface between applications running on the computer system and the calendar, in some implementations, the client calendar interface may be an interface between the computer system's operating system and the calendar. Moreover, one or more of the applications, the client calendar interface, and the calendar application may run on distinct electronic devices. For example, the calendar application may run on a mobile phone and the client calendar interface may provide information about the shared content, and prompt the calendar application on the mobile phone to create a content listing for the shared content.

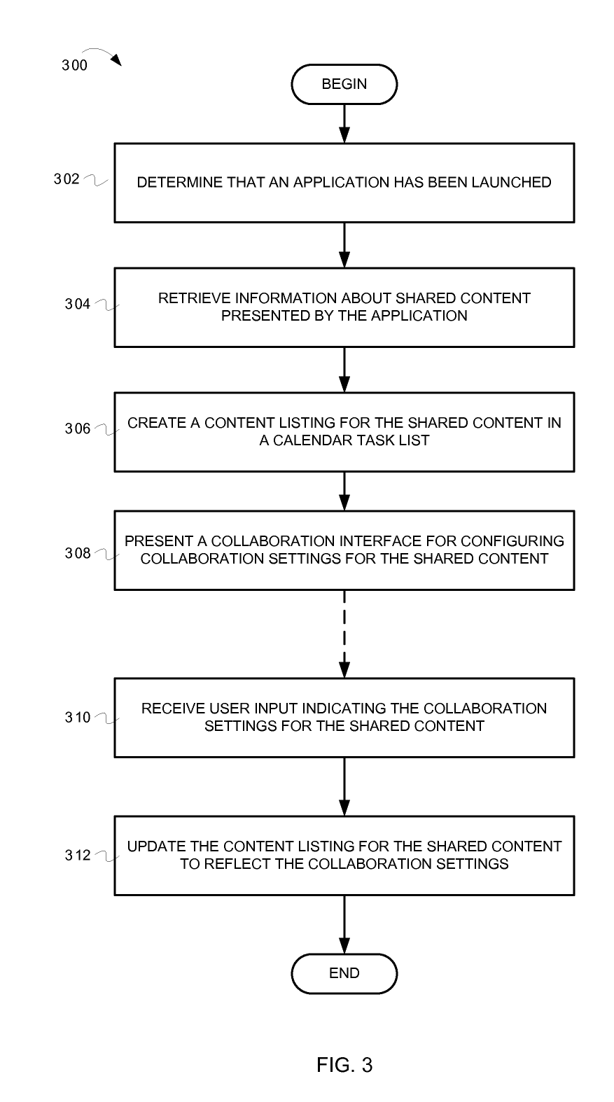

FIG. 3 is a flow diagram illustrating example operations for creating a calendar content listing for shared content. Flow 300 begins at block 302.

It is determined that an application has been launched (block 302). The application may be periodically queried to determine whether the application has been launched and how many instances of the application have been launched. For example, a web browser may be queried to determine how many instances of the web browser have been launched or how many tabs have been created in the web browser. In some implementations, a task manager may be queried at regular intervals of time to identify applications that have been launched within the time interval. In other implementations, the application may transmit a notification when a new instance of the application is launched. For example, the web browser may trigger a client calendar interface every time a user opens a new tab on the web browser. In another implementation, an operating system may generate an interrupt every time the application is launched, a file is opened, the application is closed, etc. The flow continues at block 304.

Information about the shared content presented by the application is retrieved (block 304). For example, the application may be a text editor and the shared content may be a project report presented by the text editor. The information about the shared content may be retrieved from metadata associated with the shared content, properties of the application set by the user, etc. For example, information such as a sender's name, a recipient's name, an email subject, a date of creation, etc. may be retrieved from an email being edited in the web browser. As another example, the metadata associated with a text document may be analyzed to retrieve information (e.g., username, user id) about the user who created the document, a date when the document was created, etc. The flow continues at block 306.

A content listing for the shared content is created in a calendar task list (block 306). The calendar content listing comprises the information about the shared content (retrieved at block 304). For example, for the text document, the calendar content listing can indicate a name of the text document, a description of the text document (e.g., as provided by the user, a retrieved first paragraph of the text document, etc.), information identifying the user who created the text document, a date and time at which the text document was created, etc. The flow continues at block 308.

A collaboration interface for configuring collaboration settings for the shared content is presented (block 308). The user can use the collaboration settings to indicate whether a work item (e.g., the text document) is to be shared, to identify other collaborators (if any), to identify the collaborators with editing access and read-only access to the shared content, etc. The collaboration interface waits for the user's input as depicted by a dashed line between blocks 308 and 310. The flow continues at block 310.

A user input indicating the collaboration settings for the shared content is received (block 310). The user can specify, via the collaboration interface, other collaborators that can edit the shared content. The user can also identify collaborators with read-only access to the shared content. The user can also indicate whether the collaborators with editing access should be allowed to concurrently edit the shared content. The flow continues at block 312.

The content listing for the shared content is updated to reflect the configured collaboration settings (block 312). For example, the content listing for the text document, in the calendar task list, may indicate whether the collaborators can concurrently edit the text document. The calendar content listing can also specify which of the collaborators have editing access and which of the collaborators have read-only access to the shared content. In some implementations, after the content listing for the shared content is updated, the content listing may be stored on a server and/or transmitted to the other collaborators. From block 312, the flow ends.

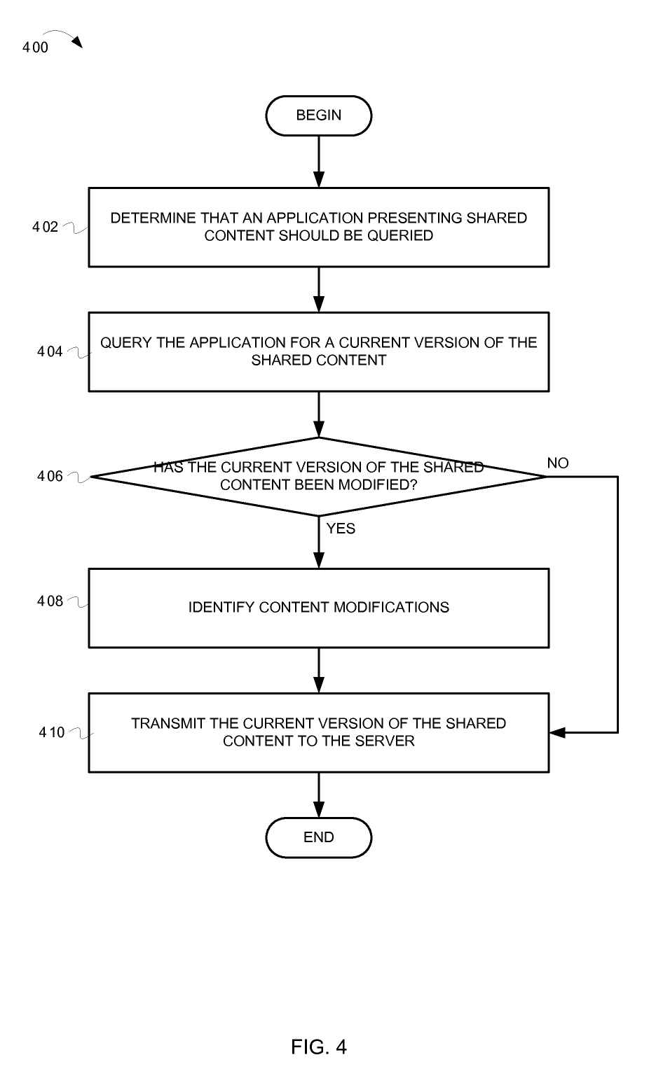

FIG. 4 is a flow diagram illustrating example operations for sharing content via a client calendar interface. Flow 400 begins at block 402.

It is determined that an application presenting shared content should be queried (block 402). A content listing in a calendar task list may indicate how often a current version of the shared content should be retrieved and stored on a content database on the server. In some implementations, the application presenting the shared content may be queried every pre-defined interval of time. In other implementations, the current version of the shared content may be retrieved in response to detecting a user input on the application. The flow continues at block 404.

The application is queried for the current version of the shared content (block 404). For example, a text editor may be queried to retrieve a current version of the shared content presented by the text editor. The flow continues at block 406.

It is determined whether the current version of the shared content has been modified (block 406). A client calendar interface running on a user's computer system may retrieve (e.g., from a server, from memory on a local machine, etc.) a last stored version of the shared content, compare the last stored version of the shared content with the current version of the shared content (retrieved at block 406), and identify modifications made to the shared content (“content modifications”). In another implementation, the application may detect and keep track of the content modifications. The application may notify the client calendar interface of the content modifications when the application is queried for the current version of the shared content. If it is determined that the current version of the shared content has been modified, the flow continues a block 408. Otherwise, the flow continues at block 410.

The content modifications are identified (block 408). As described earlier, the client calendar interface may compare the available versions of the shared content to identify the content modifications or may receive the content modifications from the application. The flow continues at block 410.

The current version of the shared content is transmitted for storage on the server (block 410). In addition to transmitting the current version of the shared content to the server, some information associated with the shared content may also be transmitted to the server. For example, information identifying the user who edited the shared content and a date and time at which the shared content was edited may be transmitted. In some implementations, an indication of the shared content such as a location of the shared content, a name associated with the shared content, a snapshot of the shared content illustrating the content modification, etc. may be transmitted. Additionally, the content modifications may also be transmitted (e.g., as part of shared content metadata) to the server. From block 410, the flow ends.

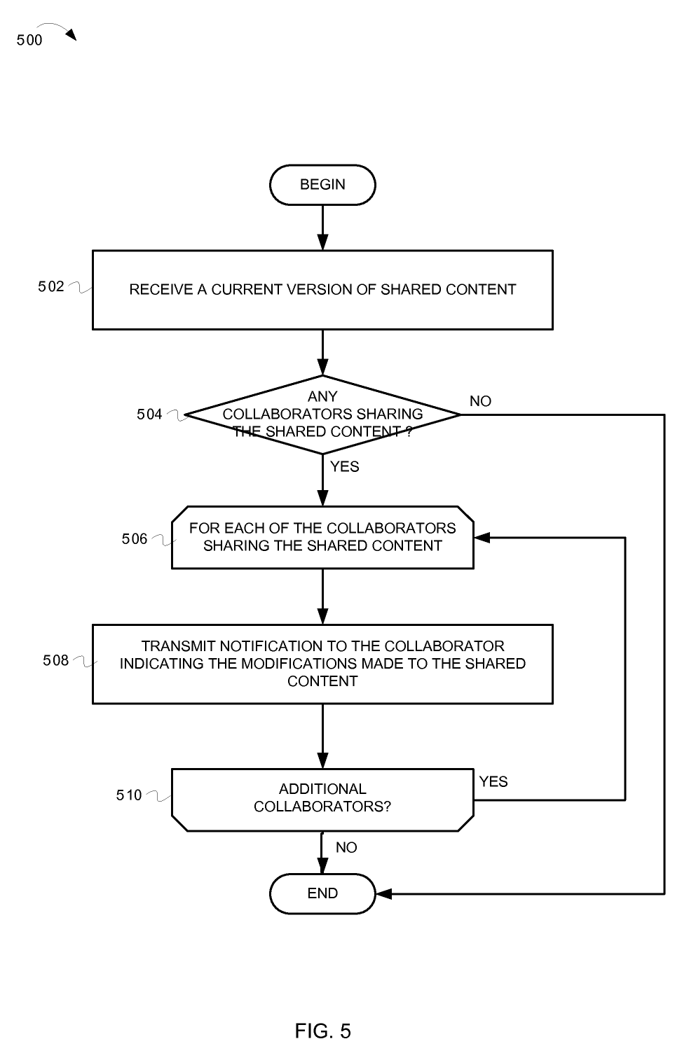

FIG. 5 is a flow diagram illustrating example operations for creating and transmitting notifications in a collaborative environment via a client calendar interface. Flow 500 begins at block 502.

A current version of shared content is received (block 502). In addition to receiving the current version of the shared content, other information such as a user who edited the shared content, a date and time at which the shared content was edited and content modifications made to the shared content may also be received. The other information associated with the shared content may be received as a separate file or may be received as part of metadata for the shared content. The flow continues at block 504.

It is determined whether the shared content is being shared among other collaborators (block 504). In one implementation, the server can identify the collaborators by accessing a content listing in a stored calendar task list for the shared content. As indicated earlier, the content listing for the shared content may be stored on the server. In another implementation, the client calendar interface may indicate to the server (e.g., as part of the metadata for the current version of the shared content) the collaborators with editing access and read-only access to the shared content. The flow continues at block 506.

A loop is begun to perform a set of operations (described in block 508) for each of the collaborators sharing the shared content (block 506). At block 506, it is also determined whether there exists another collaborator to whom a notification should be transmitted. A next collaborator for the shared content is identified and the loop executes for the next collaborator. For each of the collaborators, the flow continues at block 508.

A notification indicating the content modifications is transmitted to the collaborator (block 508). The server transmits the notification to the collaborator via the collaborator's client calendar interface. The client calendar interface may present the notification on the calendar application. The notification can indicate a collaborator that modified the shared content, a date/time at which the shared content was modified, and the content modifications. The flow continues at block 510

The loop for each of the identified collaborators ends (block 510). If there are additional collaborators to whom the notifications should be transmitted, then control flows back to block 506, where the next collaborator is identified and the operations described with reference to block 508 are performed for the next collaborator. The loop ends when it is determined that the loop operations (block 508) have been performed for every collaborator associated with the shared content.

It should be noted that the operations described in the flow diagrams (FIGS. 3-5) are examples meant to aid in understanding embodiments, and should not be used to limit embodiments or limit scope of the claims. Embodiments may perform additional operations, fewer operations, operations in a different order, operations in parallel, and some operations differently. For example, the status of the shared content may also be queried at block 404. The status of the shared content can indicate whether the user is currently editing the shared content. In one implementation, it may be determined whether the application presenting the shared content is in the foreground of the user's desktop. In another implementation, a time when the shared content was last modified may be determined. If the application presenting the shared content has been idle for more than a specified interval of time, a notification may be transmitted to the user. Notifications may also be transmitted to other collaborators associated with the shared content. Thus, another collaborator (e.g., a collaborator with editing permissions) can resume working on the shared content. For example, a first collaborator writing a project report need not send the project report (e.g., via email) to a second collaborator before the first collaborator leaves for lunch. Instead, the second collaborator can retrieve the project report (e.g., from the server via the second collaborator's client calendar interface) and continue editing the project report. In some implementations, the user may also have an option of selecting types of applications for which content listings should be created. For example, the user may indicate that task listings should be created for files presented by the text editor, while task listings should not be created for files presented by an audio player.

Also, the client calendar interface can retrieve, from the server, and present different versions of the shared content on the calendar. The calendar may present links to the different versions of the shared content as part of the content listing for the shared content (e.g., in the “version” column of the calendar content listing 112 of FIG. 1). A merged version of the shared content, comprising content modifications from all the collaborators may also be presented. The content modifications made by each of the collaborators may be highlighted (e.g., using different fonts, different font colors, etc.) in the merged version of the shared content.

Also, although FIG. 4 describes the client calendar interface configured to detect content modifications in the shared content, in some implementations, the client calendar interface may not identify and transmit the content modifications to the server. Instead, the server may compare the current version of the shared content with a last stored version of the shared content, and determine that the shared content has been modified. Also, in some implementations, the collaborators may have an option of choosing (via their respective client calendar interfaces) whether or not they wish to receive notifications of the content modifications. For example, the collaborator may indicate (e.g., as part of configuring collaboration settings for the shared content, in the content listing for the shared content) that he/she does not wish to receive the notifications. Based on the collaboration settings, the server may transmit the notifications to collaborators that wish to receive the notifications. The collaborators may also have an option to indicate via the transmitted notifications (e.g., clicking on a GUI object on the notification) that no further notifications should be transmitted.

Based on the notifications received by the client calendar interface, the content listing for the shared content may be updated to reflect a latest version of the shared content. For example, as depicted in FIG. 1, the “content with timestamp” column in the calendar task list 110 may be updated to indicate the user who last modified the shared content, and the date and time at which the shared content was modified. In some implementations, only the latest version of the shared content from each collaborator may be stored. For example, a current version of the shared content edited by a first collaborator and a current version of the shared content edited by a second collaborator may be stored. Previously stored versions of the shared content as edited by the first collaborator may be overwritten to store the current version of the shared content edited by the first collaborator. In another implementation, every version of the shared content retrieved from the collaborators may be stored on the server.

Lastly, it should also be noted that although the flowcharts and the conceptual diagrams (FIG. 1-2) are described as comprising a client component (e.g., the client calendar interface) and a server component (e.g., the collaboration unit), any/all of the functionality may be implemented by either/both the server and the client. For example, in some implementations, the server may not comprise a collaboration unit. Instead, the client calendar interface may store the current version of the shared content, identify the content modifications, identify the collaborators of the shared content, and use the server to transmit notifications to the other collaborators (e.g., an email notification, an instant message, etc).

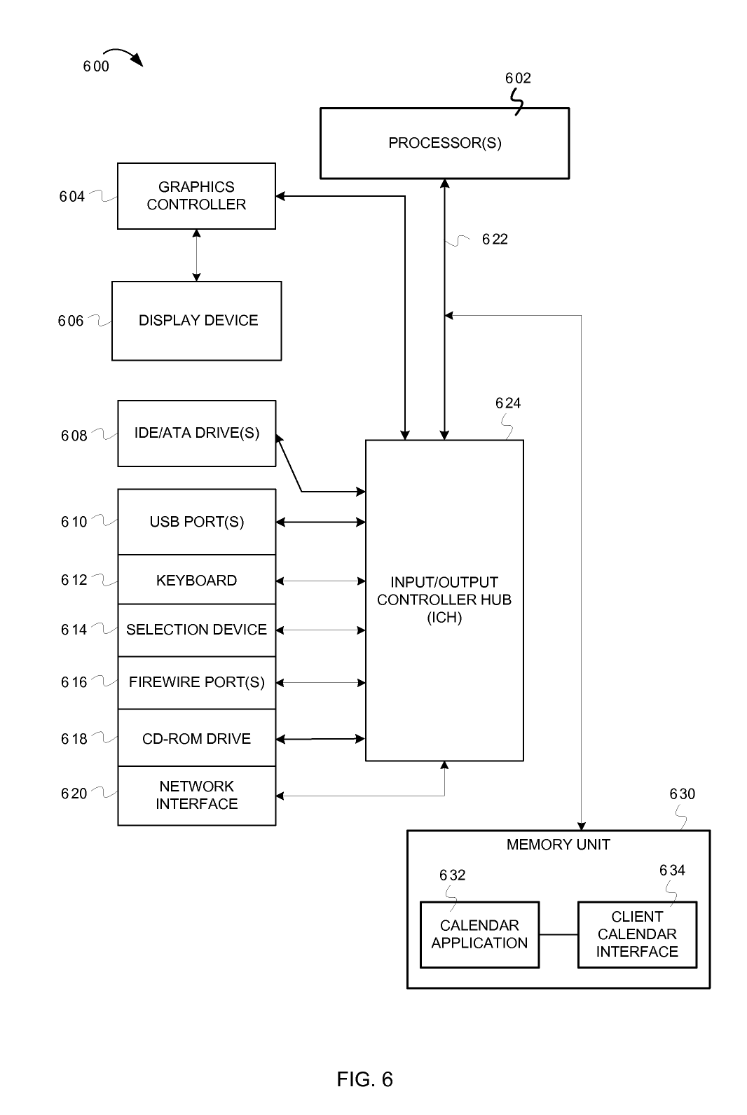

FIG. 6 is an example computer system configured for managing shared content via a calendar application. The computer system 600 includes a processor 602. The processor 602 is connected to an input/output controller hub 624 (ICH), also known as a south bridge, via a bus 622 (e.g., PCI, ISA, PCI-Express, HyperTransport, etc). A memory unit 630 interfaces with the processor 602 and the ICH 624. The main memory unit 630 can include any suitable random access memory (RAM), such as static RAM, dynamic RAM, synchronous dynamic RAM, extended data output RAM, etc

The memory unit 630 comprises a calendar application 632 and a client calendar interface 634. The client calendar interface 634 acts as an interface between the calendar application 632 and other applications (not shown) running on the computer system 600. The client calendar interface 634 performs operations for accessing the shared content, keeping track of the available versions of the shared content, and notifying (via a server) other collaborators of a change in status or a current version of the shared content in accordance with the operations described with reference to FIGS. 1-5.

The ICH 624 connects and controls peripheral devices. In FIG. 6, the ICH 624 is connected to IDE/ATA drives 608 and to universal serial bus (USB) ports 610. The ICH 624 may also be connected to a keyboard 612, a selection device 614, firewire ports 616, CD-ROM drive 618, and a network interface 620. The ICH 624 can also be connected to a graphics controller 604. The graphics controller is connected to a display device 606 (e.g., monitor). In some embodiments, the computer system 600 can include additional devices and/or more than one of each component shown in FIG. 6 (e.g., video cards, audio cards, peripheral devices, etc.). For example, in some instances, the computer system 600 may include multiple processors, multiple cores, multiple external CPU's. In other instances, components may be integrated or subdivided.

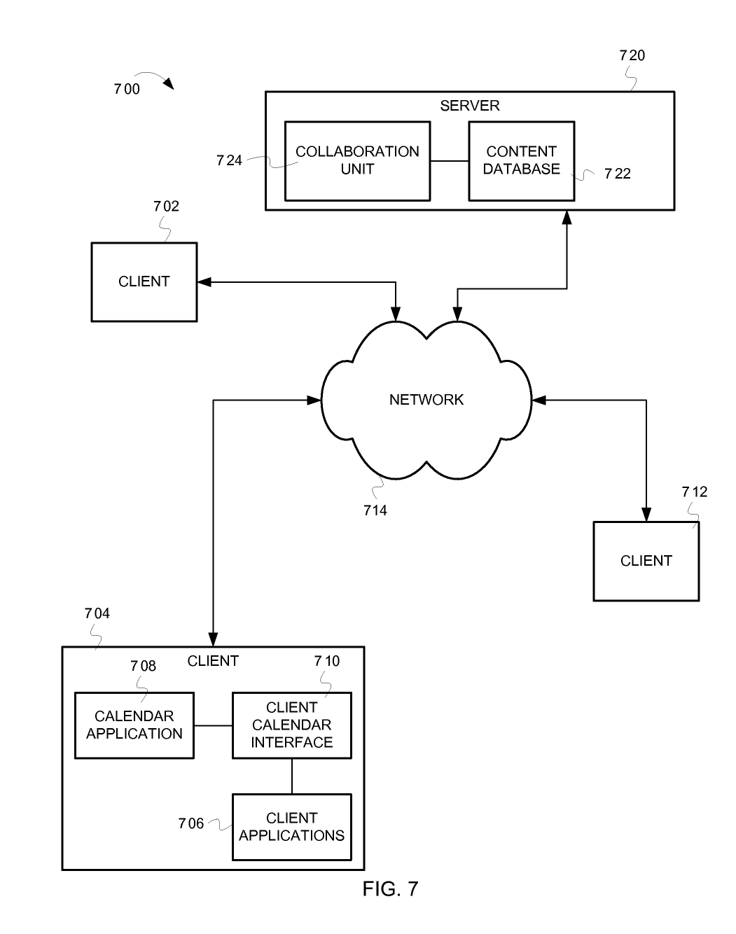

FIG. 7 is an example block diagram configured for accessing shared content via a client calendar interface. The system 700 comprises a server 720 and clients 702, 704, and 712. The server 720 comprises a content database 722 and a collaboration unit 724. The collaboration unit 724 is coupled with the content database 722. The clients 702, 704, and 712 comprise a calendar application 708, a client calendar interface 710, and client applications 706. The client calendar interface 710 acts as an interface between the calendar application 708 and the client applications 706.

The client calendar interface 710 identifies applications 706 running on the client 704 and prompts the user to configure collaboration settings for the shared content presented by the application 706. The client calendar interface 710 also prompts the calendar application 708 to create a calendar content listing for the shared content based on the collaboration settings. The client calendar interface 710 can also retrieve a current version of the shared content, from the application 706, and transmit the current version of the shared content to the collaboration unit 724. The collaboration unit 724 can store the current version of the shared content in the content database 722. The collaboration unit 724 can also transmit notifications to other collaborators (e.g., on the clients 702 and 712) for presentation on the other collaborators' calendar applications. The notifications may be used to indicate modifications made to the shared content.

The server 720 and the clients 702, 704, and 712 communicate via a communication network 714. The communication network 714 can include any technology (e.g., Ethernet, IEEE 802.11n, SONET, etc) suitable for passing communication between the server 720 and the clients 702, 704, and 712. Moreover, the communication network 714 can be part of other networks, such as cellular telephone networks, public-switched telephone networks (PSTN), cable television networks, etc. Additionally, the server 720 and the clients 702, 704, and 712 can be any suitable devices capable of executing software in accordance with the embodiments described herein. The client calendar interface 710 on the client 704 and/or the collaboration unit 724 on the server 720 may be implemented as a chip, plug-in, code in memory, etc.

Embodiments may take the form of a hardware embodiment, a software embodiment (including firmware, resident software, micro-code, etc.) or an embodiment combining software and hardware aspects that may all generally be referred to herein as a “circuit,” “module” or “system”. Furthermore, embodiments of the inventive subject matter may take the form of a computer program product embodied in any tangible medium of expression having computer usable program code embodied in the medium. The described embodiments may be provided as a computer program product, or software, that may include a machine-readable medium having stored thereon instructions, which may be used to program a computer system (or other electronic device(s)) to perform a process according to embodiments, whether presently described or not, since every conceivable variation is not enumerated herein. A machine-readable medium includes any mechanism for storing or transmitting information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read only memory (ROM); random access memory (RAM); erasable programmable memory (e.g., EPROM and EEPROM); flash memory; or other types of medium suitable for storing electronic instructions. In addition, embodiments may be embodied in an electrical, optical, acoustical or other form of propagated signal (e.g., carrier waves, infrared signals, digital signals, etc.), or wireline, wireless, or other communications medium.

Computer program code for carrying out operations of the embodiments may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a personal area network (PAN), or a wide area network (WAN), or the connection may be made to an external computer (for example, through the Internet using an Internet Service Provider).

While the embodiments are described with reference to various implementations and exploitations, it will be understood that these embodiments are illustrative and that the scope of the inventive subject matter is not limited to them. In general, an interface for retrieving shared content in a collaborative environment using a calendar task list as described herein may be implemented with facilities consistent with any hardware system or hardware systems. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A computer-implemented method comprising:
detecting that an application for presenting a local version of a shared content has been launched, wherein the shared content comprises content shared among a plurality of clients for collaboration;
receiving collaboration settings indicating the plurality of clients collaborating on the shared content and indicating permissions associated with each of the plurality of clients for manipulating the shared content;
creating a content listing for the shared content, wherein the content listing indicates the collaboration settings for the shared content;
transmitting the content listing to a collaboration unit on a server for storing in a content database;
determining a modification of a current local version of the shared content; and
communicating the modification and an indication of the current local version of the shared content.

2. The computer-implemented method of claim 1, further comprising:
presenting a current status of the shared content in response to a notification indicating the current status of the shared content, wherein the current status differs from a previous status;
presenting links to a plurality of versions of the shared content, wherein each of the plurality of versions of the shared content is a current local version of the shared content received from respective ones of the plurality of clients;
detecting a selection of a first of the plurality of versions of the shared content; and
retrieving, from the content database, the first of the plurality of versions of the shared content in response to said detecting the selection of the first of the plurality of versions.

3. The computer-implemented method of claim 1, further comprising:
identifying other of the plurality of clients based on one of accessing the content listing for the shared content, and indicating the other of the plurality of clients; and
transmitting, to the other of the plurality of clients, at least one of the modification and the indication of the current local version of the shared content.

4. The computer-implemented method of claim 1, further comprising:
querying the application at regular intervals of time for at least one of a latest local version of the shared content and a second modification.

5. The method of claim 1, wherein the collaboration settings comprise at least one of a first set of the plurality of clients with permissions to edit the shared content, a second set of the plurality of clients with read-only access to the shared content, and a concurrent editing policy for the shared content.

6. The method of claim 5, wherein the content listing for the shared content indicates at least one of the first set of the plurality of clients with permissions to edit the shared content, the second set of the plurality of clients with read-only access to the shared content, the concurrent editing policy for the shared content, a current status of the shared content, a latest version of the shared content, previous versions of the shared content, and a due time for the shared content.

7. The method of claim 1, further comprising:
determining that a due time associated with the shared content is within a defined time interval;
presenting a notification indicating that the due time associated with the shared content is within the defined time interval; and
transmitting, to other of the plurality of clients the notification indicating that the due time associated with the shared content is within the defined time interval.

8. The method of claim 1, wherein the determining the modification of the current local version of the shared content further comprises comparing a previous version of the shared content from a first of the plurality of clients with the current local version of the shared content from the first of the plurality of clients.

9. The method of claim 1, further comprising:
receiving, from a second of the plurality of clients, a second version of the shared content;
determining a second modification of the second version of the shared content in response to one of retrieving the second modification from metadata associated with the second version of the shared content based on a comparison of a previous version of the shared content from the second of the plurality of clients with the second version of the shared content from the second of the plurality of clients, and retrieving the second modification from metadata associated with the second version of the shared content based on the second of the plurality of clients recording the second modification; and
transmitting a notification to other of the plurality of clients indicating the second modification.

10. A computer program product for shared content retrieval, the computer program product comprising:
a computer usable medium having computer usable program code embodied therewith, the computer usable program code configured to:
detect that an application for presenting a local version of a shared content has been launched, wherein the shared content comprises content shared among a plurality of clients for collaboration;
receive collaboration settings indicating the plurality of clients collaborating on the shared content and indicating permissions associated with each of the plurality of clients for manipulating the shared content;
create a content listing for the shared content, wherein the content listing indicates the collaboration settings for the shared content;
transmit the content listing to a collaboration unit on a server, for storing in a content database;
determine a modification of a current local version of the shared content; and
communicate the modification and an indication of the current local version of the shared content.

11. The computer program product of claim 10, wherein the computer usable program code is further configured to:
present a current status of the shared content in response to a notification indicating the current status of the shared content, wherein the current status differs from a previous status;
present links to a plurality of versions of the shared content, wherein each of the plurality of versions of the shared content is a current local version of the shared content received from respective ones of the plurality of clients;
detect a selection of a first of the plurality of versions of the shared content; and
retrieve, from the content database, the first of the plurality of versions of the shared content in response to the computer usable program code detecting the selection of the first of the plurality of versions.

12. The computer program product of claim 10, wherein the collaboration settings comprise at least one of a first set of the plurality of clients with permissions to edit the shared content, a second set of the plurality of clients with read-only access to the shared content, and a concurrent editing policy for the shared.

13. The computer program product of claim 12, wherein the content listing for the shared content indicates at least one of the first set of the plurality of clients with permissions to edit the shared content, the second set of the plurality of clients with read-only access to the shared content, the concurrent editing policy for the shared content, a current status of the shared content, a latest version of the shared content, previous versions of the shared content, and a due time for the shared content.

14. The computer program product of claim 10, wherein the computer usable program code is further configured to:
determine that a due time associated with the shared content is within a defined time interval;
present a notification indicating that the due time associated with the shared content is within the defined time interval; and
transmit, to other of the plurality of clients, the notification indicating that the due time associated with the shared content is within the defined time interval

15. The computer program product of claim 10, wherein the computer usable program code is further configured to query the application at regular intervals of time for at least one of a latest local version of the shared content and a second modification

16. The computer program product of claim 10, wherein the computer usable program code configured to determine the modification of the current local version of the shared content further comprises the computer usable program code configured to compare a previous version of the shared content from a first of the plurality of clients with the current local version of the shared content from the first of the plurality of clients.

17. An apparatus comprising:
a processor;
a network interface coupled with the processor; and
a machine-readable media encoded with a client calendar interface configured to:
detect that an application for presenting a local version of a shared content has been launched, wherein the shared content comprises content shared among a plurality of clients for collaboration;
receive collaboration settings indicating the plurality of clients collaborating on the shared content and indicating permissions associated with each of the plurality of clients for manipulating the shared content;
create a content listing for the shared content, wherein the content listing indicates the collaboration settings for the shared content;
transmit the content listing to a collaboration unit on a server, for storing in a content database;
determine a modification of a current local version of the shared content; and
communicate the modification and an indication of the current local version of the shared content.

18. The apparatus of claim 17, wherein the machine-readable media encoded with the client calendar interface is further configured to:
present a current status of the shared content in response to a notification indicating the current status of the shared content, wherein the current status differs from a previous status;
present links to a plurality of versions of the shared content, wherein each of the plurality of versions of the shared content is a current local version of the shared content received from respective ones of the plurality of clients;
detect a selection of a first of the plurality of versions of the shared content; and
retrieve, from the content database, the first of the plurality of versions of the shared content in response to the client calendar interface detecting the selection of the first of the plurality of versions.

19. The apparatus of claim 17, wherein the collaboration settings comprise at least one of a first set of the plurality of clients with permissions to edit the shared content, a second set of the plurality of clients with read-only access to the shared content, and a concurrent editing policy for the shared content.

20. The apparatus of claim 17, wherein the machine-readable media encoded with the client calendar interface is further configured to query the application at regular intervals of time for at least one of a latest local version of the shared content and a second modification.
